(19) United States
(12) Patent Application Publication
(10) Pub. No.: US 2021/0332572 A1
(43) Pub. Date: Oct. 28, 2021

(54) Information Pushing Method and System for Smart Faucet

(71) Applicant: Shenzhen Uluru Technolongy Engineering Co., Ltd., Shenzhen (CN)

(72) Inventor: JiaHong TANG, Shenzhen (CN)

(73) Assignee: Shenzhen Uluru Technolongy Engineering Co., Ltd., Shenzhen (CN)

(21) Appl. No.: 16/457,839

(22) Filed: Jun. 28, 2019

Related U.S. Application Data
(63) Continuation of application No. PCT/CN2018/092156, filed on Jun. 21, 2018.

(30) Foreign Application Priority Data
Nov. 24, 2017 (CN) 201711192066.5

(51) Int. Cl. E03C 1/05; E03C 1/04; F16K 31/02; G06F 21/32; G06F 21/34

(52) U.S. Cl. CPC E03C 1/057; E03C 1/0404; G06F 21/34; G06F 21/32; F16K 31/02

(57) ABSTRACT

The present disclosure relates to the technical field of faucets, in particular to an information pushing method and system for a smart faucet. According to the information pushing method and system for the smart faucet of the present disclosure, a trigger signal and a termination signal are acquired by the faucet; an information pushing duration is obtained through calculation based on the trigger signal and the termination signal; and fee-based information is obtained through calculation based on the information pushing duration. Therefore, the duration during which a user actually receives the information pushed by the faucet is reflected, real statistical data which can be provided for an information provider, and meanwhile, an intelligence life experience is brought to users.

### CROSS-REFERENCE TO RELATED APPLICATIONS

This application claims all benefits accruing under 35 U.S.C. § 119 from China Patent Application No. 201711192066.5, filed on Nov. 24, 2017 in the State Intellectual Property Office of China, the content of which is hereby incorporated by reference. This application is a continuation under 35 U.S.C. § 120 of international patent application PCT/CN2018/092156 filed on Jun. 21, 2018, the content of which is also hereby incorporated by reference.

### TECHNICAL FIELD

The present disclosure relates to the technical field of faucets, in particular to an information pushing method and system for a smart faucet.

### BACKGROUND

Faucets are of a necessity in our lives, and the average number of times people use faucets every day is between 6 times and 8 times. Although the locations at which the faucets are used may be different, it may be confirmed that the faucets are of a necessity in people's lives. Therefore, with the development of the Internet of Things technology, the way to effectively use the faucet and make it intelligent to serve human beings more convenient and simple life will become a new living need of human beings.

### SUMMARY

With respect to the above problems, the present disclosure provides an information pushing method and system for a smart faucet.

The solution to the technical problem of the present disclosure is to provide an information pushing method for a smart faucet. The faucet is configured to be connected to a remote terminal. The information pushing method for the smart faucet comprises the following steps:

S1: acquiring, by the faucet, a trigger signal;

S2: starting information pushing timing according to the trigger signal;

S3: acquiring, by the faucet, a termination signal and terminating the information pushing timing;

S4: obtaining, by the faucet, an information pushing duration through calculation based on the trigger signal and the termination signal, and transmitting the information pushing duration to the remote terminal; or transmitting, by the faucet, the trigger signal and the termination signal to the remote terminal, and obtaining, by the remote terminal, an information pushing duration through calculation; and

S5: obtaining, by the remote terminal, fee-based information through calculation based on the information pushing duration.

Preferably, in step S2, the faucet is triggered to discharge water while performing the information pushing timing according to the trigger signal; and in step S4, the faucet stops discharging water while acquiring the termination signal and terminating the information pushing timing.

Preferably, the step S2 specifically comprises the following steps:

S21: generating, by the faucet, a feedback signal according to the trigger signal, and transmitting the feed signal to the remote terminal; and

S22: receiving, by the remote terminal, the feedback signal, and then transmitting a control signal to the faucet to control the faucet to perform information pushing.

Preferably, the remote terminal comprises an information database in which information to be pushed is stored. The step S22 is specifically as follows:

the remote terminal selects information to be pushed from the information database and transmits the information to the faucet which then pushes the selected information.

Preferably, the information pushing method for the smart faucet further comprises the following steps:

S6a: acquiring, by a plurality of clients, bidding notification information from the remote terminal;

S6b: feeding back, by the plurality of clients, bidding information to the remote terminal, respectively;

S6c: comparing, by the remote terminal, the plurality of bidding information;

S6d: selecting, by the remote terminal, one or more clients according to a comparison result; and

S6e: transmitting, by the selected client, the information that needs to be pushed to the remote terminal, and saving the information in the information database.

Preferably, the information pushing method for the smart faucet further comprises the following steps:

S7a: acquiring identity information of a user; and

S7b: storing the user's identity information in the information database in association with the currently pushed information.

Preferably, the information is stored in the database in a classified manner. The information pushing method for the smart faucet further comprises the following steps:

S7c: storing other information which is of the same category as the currently pushed information in association with the user's identity information, and pushing the other information to the user.

Preferably, the remote terminal further comprises an identification database in which identity information is stored, the identity information being associated with one or more pieces of information in the information database. The step S22 specifically comprises the following steps:

S22: acquiring identity information of a current user;

S222: matching the identity information of the current user with the identity information stored in the identification database; performing step S223 if the identity information of the current user is matched with one piece of identity information stored in the identification database; and performing step S224 if the identity information of the current user is not matched with any identity information stored in the identification database;

S223: selecting information associated with this identity information from the information database, and transmitting the selected information to the faucet; and

S224: selecting information from the information database randomly or according to a priority level, and transmitting the selected information to the faucet.

Preferably, the remote terminal further comprises an identification database in which identity information is stored, the identity information being associated with one or more signals in the information database. The information pushing method for the smart faucet further comprises the following steps:

S8a: acquiring identity information of a current user;

S8b: matching the identity information of the current user with the identity information stored in the identification database;

S8c: selecting information associated with the identity information of the current user from the information database, and transmitting item acquisition information of the associated information to the faucet for pushing; or when the identity information of the current user is not matched with the identity information stored in the identification database, selecting information from the information database randomly or according to a priority level, and transmitting item acquisition information of the information to the faucet for pushing;

S8d: allowing the client to access the item acquisition information and to initiate a purchase request; and

S8e: responding, by the remote terminal, the purchase request, and performing a transaction with the client.

Preferably, in the step S221 or the step S8a, the identity information is acquired by using face recognition or personal mobile phone MAC identifier recognition.

Preferably, the trigger signal is acquired by sensing user's hands reaching a prescribed area or by sensing a user who approaches the faucet. The termination signal is acquired by sensing the user's hands leaving from the prescribed area or by sensing the user moving away from the faucet.

The present disclosure further provides an information pushing system for a smart faucet. The information pushing system for the smart faucet comprises:

the faucet, which comprises an action sensing module configured to acquire a trigger signal and a termination signal;

an information pushing module configured to start information pushing according to the trigger signal;

a processing module configured to obtain an information pushing duration through calculation based on the trigger signal and the termination signal;

a communicating module configured to communicate with a memory;

the memory; and one or more programs, one or more programs being stored in the memory, the memory being in communication with the faucet, and the program being used for executing the following step instruction:

obtaining fee-based information through calculation based on the information pushing duration.

Preferably, the faucet further comprises a switch module configured to control the faucet to discharge water or stop discharging water according to the trigger signal or the termination signal.

Preferably, when the memory comprises an information database, the program further executes the following step instructions:

acquiring identity information of a user; and

storing the user's identity information in association with the currently pushed information.

Preferably, when the memory comprises an identification database, the program further executes the following step instructions:

S221: acquiring identity information of a current user;

S222: matching the identity information of the current user with the identity information stored in the identification database; performing step S223 if the identity information of the current user is matched with one piece of identity information stored in the identification database; and performing step S224 if the identity information of the current user is not matched with any identity information stored in the identification database;

S223: selecting information associated with this identity information from the information database, and transmitting the selected information to the faucet; and

S224: selecting information from the information database randomly or according to a priority level, and transmitting the selected information to the faucet.

Preferably, when the memory further comprises an identification database, the program further executes the following step instructions:

S8a: acquiring identity information of a current user;

S8b: matching the identity information of the current user with identity information stored in the identification database;

S8c: selecting information associated with the identity information of the current user from the information database, and transmitting item acquisition information of the associated information to the faucet for pushing; or when the identity information of the current user is not matched with the identity information stored in the identification database, selecting information from the information database randomly or according to a priority level, and transmitting item acquisition information of this information to the faucet for pushing;

S8d: allowing the client to access the item acquisition information and to initiate a purchase request; and

S8e: responding, by the remote terminal, the purchase request, and performing a transaction with the client.

Preferably, the information pushing module is obliquely arranged on the upper surface of the faucet.

The information pushing method for the smart faucet of the present disclosure differs from the prior art in that: the faucet is configured to be connected with the remote terminal, The information pushing method for the smart faucet comprises the following steps: S1: acquiring, by the faucet, a trigger signal; S2: triggering the faucet to discharge water according to the trigger signal, and meanwhile performing information pushing while the faucet discharges water; S3: acquiring, by the faucet, a termination signal and stopping discharging water; S4: obtaining, by the faucet, an information pushing duration through calculation based on the trigger signal and the termination signal, and transmitting the information pushing duration to the remote terminal; and S5: obtaining, by the remote terminal, fee-based information through calculation based on the information pushing duration. According to the information pushing method for the smart faucet of the present disclosure, the trigger signal and the termination signal are acquired by the faucet, the information pushing duration is obtained through calculation based on the trigger signal and the termination signal, and the fee-based information is obtained through calculation based on the information pushing duration. Therefore, the duration during which a user actually receives the information pushed by the faucet is really reflected, real statistical data can be provided for an information provider, and meanwhile, an intelligence life experience is brought to users.

In addition, according to the information pushing method for the smart faucet of the present disclosure, the number of times of information pushing is obtained through calculation based on the number of times that the remote terminal transmits information to the faucet, and the fee-based information is obtained through calculation based on the number of times of information pushing and the information pushing duration. Therefore, the duration during which the user actually receives the information pushed by the faucet is reflected more really.

In addition, the information pushing method for the smart faucet of the present disclosure can provide a bidding platform for an information provider, so that information provided by the information provider can be pushed to the public on the faucet.

In addition, according to the information pushing method for the smart faucet of the present disclosure, the user's identity information is obtained by using a face recognition technology or personal mobile phone MAC identifier recognition. The user's identity information is stored in association with the currently pushed information, or other information which is of the same category as the currently pushed information is stored in association with the user's identity information. The user is labeled according to types of user's favorite information. When the user continues to use the faucet of the present disclosure to wash hands later, the remote terminal may select to push the user's favorite information or an item sales link corresponding to this information. Therefore, a better user experience is brought to each user by pushing his favorite information or item sales link. In addition, the entire information processing process is fast and easy, which is conductive to promotion and application of intelligent home products.

Moreover, the information pushing system for the smart faucet of the present disclosure also has the above-mentioned advantages.

### BRIEF DESCRIPTION OF THE DRAWINGS

FIG. 1 is a flow diagram of an information pushing information for a smart faucet according to the first embodiment of the present disclosure.

FIG. 2 is a sub-flow diagram in step S2 of the information pushing method for the smart faucet according to the first embodiment of the present disclosure.

FIG. 3 is a flow diagram of a variation of the information pushing method for the smart faucet according to the first embodiment of the present disclosure.

FIG. 4 is a flow diagram of another variation of the information pushing method for the smart faucet according to the first embodiment of the present disclosure.

FIG. 5 is a sub-flow diagram in step S22 of the information pushing method for the smart faucet according to the first embodiment of the present disclosure.

FIG. 6 is a flow diagram of yet another variation of the information pushing method for the smart faucet according to the first embodiment of the present disclosure.

FIG. 7 is a flow diagram of yet another variation of the information pushing method for the smart faucet according to the first embodiment of the present disclosure.

FIG. 8 is a schematic diagram of modules of an information pushing system for a smart faucet according to the second embodiment of the present disclosure.

FIG. 9 is a schematic diagram of a faucet in the information pushing system for the smart faucet according to the second embodiment of the present disclosure.

### DETAILED DESCRIPTION

In order to understand the objective, the technical solution and the advantages of the present disclosure more clearly, the present disclosure will be further described in detail below with reference to the accompanying drawings and embodiments. It should be understood that the specific embodiments described herein are merely illustrative of the present disclosure and are not intended to limit the present disclosure.

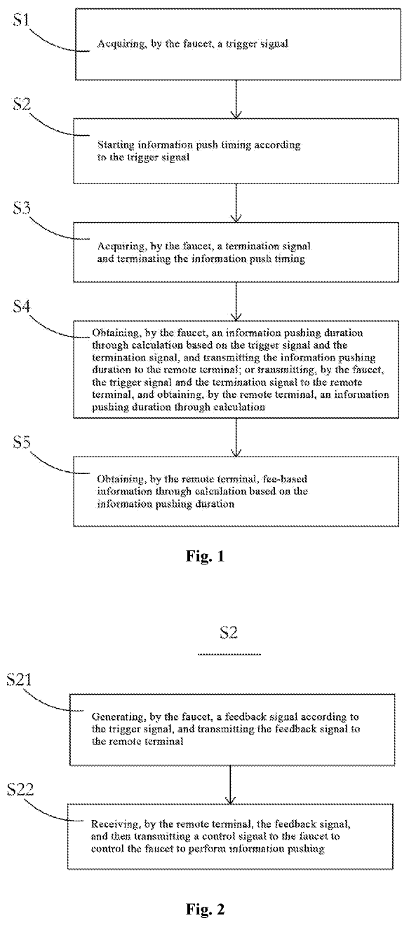

Referring to FIG. 1, the first embodiment of the present disclosure provides an information pushing method for a smart faucet, the faucet being configured to be connected with a remote terminal. The information pushing method for the smart faucet comprises the following steps:

S1: acquiring, by the faucet, a trigger signal;

S2: starting information pushing timing according to the trigger signal;

S3: acquiring, by the faucet, a termination signal and terminating the information pushing timing;

S4: obtaining, by the faucet, an information pushing duration through calculation based on the trigger signal and the termination signal, and transmitting the information pushing duration to the remote terminal; or transmitting, by the faucet, the trigger signal and the termination signal to the remote terminal, and obtaining, by the remote terminal, an information pushing duration through calculation; and

S5: obtaining, by the remote terminal, fee-based information through calculation based on the information pushing duration.

It may be understood that the information referred to in the present disclosure includes, but is not limited to, advertisements, streaming media or other mediums for transmitting messages to users. In all embodiments of the present disclosure, information pushing is performed by arranging a display screen on the faucet.

In the step S1, the faucet acquires the trigger signal by sensing user's hands reaching a sensing area or by sensing a user who approaches the faucet. For example, a sensor is arranged on the faucet. When a user wants to wash his/her hands and put his/her hands into the sensing area of the sensor, the sensor will generate a signal. The faucet controls the opening of a valve according to the signal to start to discharge water. The sensor may be an infrared sensor, an ultrasonic sensor, an acoustic sensor or the like.

In the step S2, after receiving the trigger signal, the faucet is controlled to discharge water, while information pushing is performed on the faucet. The information pushing may be performed by arranging a display screen on the faucet to play video files and/or audio files. It may be understood that the water discharging and the information pushing of the faucet are simultaneously started; or the information pushing is performed all the time, but the water discharging is started at this time alone. Alternatively, the faucet performs information pushing on the faucet alone after receiving the trigger signal, without starting the water discharging. It may be understood that the action of starting water discharging after receiving the trigger signal is controlled by the faucet itself. When the faucet acquires the trigger signal, a time point at which the trigger signal is acquired is recorded as a starting point of the information pushing timing. It may also be understood that in order to achieve an excellent pushing effect, the display screen is usually arranged on the upper surface of the faucet obliquely. When a person washes his/her hands, his/her body usually shows a forward tilting posture, and the display screen is arranged obliquely such that the display screen is substantially parallel to the human face. Therefore, the information pushed by the display screen is acquired by the person more easily, thereby not only conforming to ergonomic requirements, but also being conducive to information pushing.

In the step S3, the faucet acquires the termination signal by sensing the user's hands leaving from the sensing area or by sensing the user moving away from the faucet. It may be understood that the faucet stops information pushing and discharging water synchronously; or the faucet stops discharging water alone, without stopping information pushing; or before stopping discharging water, the faucet stops information pushing alone. When the faucet acquires the termination signal, a time point at which the termination signal is acquired is recorded as a termination point of the information pushing timing. In addition, after acquiring the terminal signal, the faucet may also generate an electrical signal according to the terminal signal and feed back the electrical signal to the remote terminal.

In the step S4, the faucet or the remote terminal obtains the information pushing duration through calculation based on a time point of the trigger signal and a time point of the termination signal. The information pushing duration represents the time when the user actually receives the information pushed by the faucet while washing the hands. Regardless of whether the faucet starts water discharging and information pushing synchronously, or performs information pushing all the time, the water discharging is only started after the trigger signal is acquired. Alternatively, the faucet performs information pushing alone. The information push duration obtained through calculation based on the time point of the trigger signal and the time point of the termination signal is accurate and true. It may be understood that when the faucet starts to discharge water based on the trigger signal and stops discharging water based on the termination signal, the time point at which the faucet starts to discharge water may also be taken as a starting point of the information pushing timing, and the time point at which the faucet stops discharging water may be used as a termination point of the information pushing timing. As a variation, the action of performing the information pushing timing may be performed by the remote terminal. The faucet feeds back the trigger signal or the terminal signal to the remote terminal immediately after acquiring the trigger signal or the termination signal. The remote terminal obtains the information pushing duration through calculation based on the time point at which the triggering signal is acquired and the time point at which the terminal signal is acquired. It may also be understood that after the faucet pushes information once, the pushing duration of the currently pushed information is fed back to the remote terminal. After the faucet feeds back the pushing duration of this information to the remote terminal for multiple times, the remote terminal calculates a total pushing duration of this information. Alternatively, the faucet transmits the total pushing duration of this information within a preset time limit to the remote terminal within this preset time limit. The remote terminal obtains the total information pushing duration. For example, the faucet periodically feeds back the total information pushing duration to the remote terminal each month.

In the step S5, the remote terminal may obtain the fee-based information through calculation based on the information pushing duration of one time or the total pushing duration within a certain time period. The fee-based information obtained through calculation based on the information pushing duration is also accurate and true, and truly reflects the duration that the information is actually received by the public, thereby being capable of reflecting the true data to an information provider.

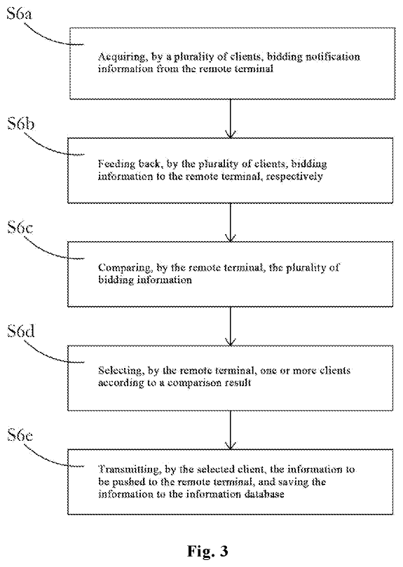

Referring to FIG. 2, the step S2 specifically comprises the following steps:

S21: generating, by the faucet, a feedback signal according to the trigger signal, and transmitting the feedback signal to the remote terminal; and

S22: receiving, by the remote terminal, the feedback signal, and then transmitting a control signal to the faucet to control the faucet to perform information pushing.

It may be understood that the faucet generates a feedback signal to notify the remote terminal after sensing an action that the user wants to wash the hands. After receiving the feedback signal, the remote terminal controls the faucet to perform information pushing. That is, the remote terminal controls the faucet to start the information pushing. As a variation, the remote terminal controls the faucet to start water discharging and perform information pushing simultaneously.

In addition, the remote terminal comprises an information database in which information to be pushed is stored. The step S22 is specifically as follows:

the remote terminal selects information to be pushed from the information database and transmits the selected information to the faucet which then pushes the selected information. It may be understood that the remote terminal may select a certain category of information or a piece of specified information from the information database for pushing. That is, the content of the pushed information is selected by the remote terminal from the information database.

Referring to FIG. 3, the information pushing method for the smart faucet further comprises the following steps:

S6a: acquiring, by a plurality of clients, bidding notification information from the remote terminal;

S6b: feeding back, by the plurality of clients, bidding information to the remote terminal, respectively;

S6c: comparing, by the remote terminal, the plurality of pieces of bidding information;

S6d: selecting, by the remote terminal, one or more clients according to a comparison result; and

S6e: transmitting, by the selected client, the information to be pushed to the remote terminal, and saving the information in the information database.

In step S6a, the remote terminal is provided with a network connection port which may be connected to an external bidding platform or an internal bidding platform. A plurality of clients may be connected to the network connection port to obtain bidding notification information from the remote terminal.

In step S6b, a plurality of clients has a demand for bidding after acquiring the bidding notification information. The plurality of clients transmits the respective bidding information to the remote terminal through the network connection port. That is, the plurality of clients informs the remote terminal of the respective bidding price.

In step S6c, after acquiring the bidding prices of the plurality of clients, the remote terminal compares the bidding prices and ranks the prices with the serial numbers according to the order of the prices from high to low.

In step S6d, after the ranked serial numbers of the plurality of clients are obtained, one or more clients are selected as successful bid clients, and the selected one or more clients are then notified.

In step S6e, after receiving the notification transmitted from the remote terminal, the selected client may transmit the information that needs to be pushed to the remote terminal and save the information in the information database. Therefore, in step S22, the remote terminal may select the information of the successful bid client from the information database to push. When there is a plurality of successful bid clients, the information provided by the clients is pushed in sequence according to priority levels of the bidding prices from high to low, or is pushed according to the priority levels of the bidding prices from high to low at different time periods of 24 hours a day.

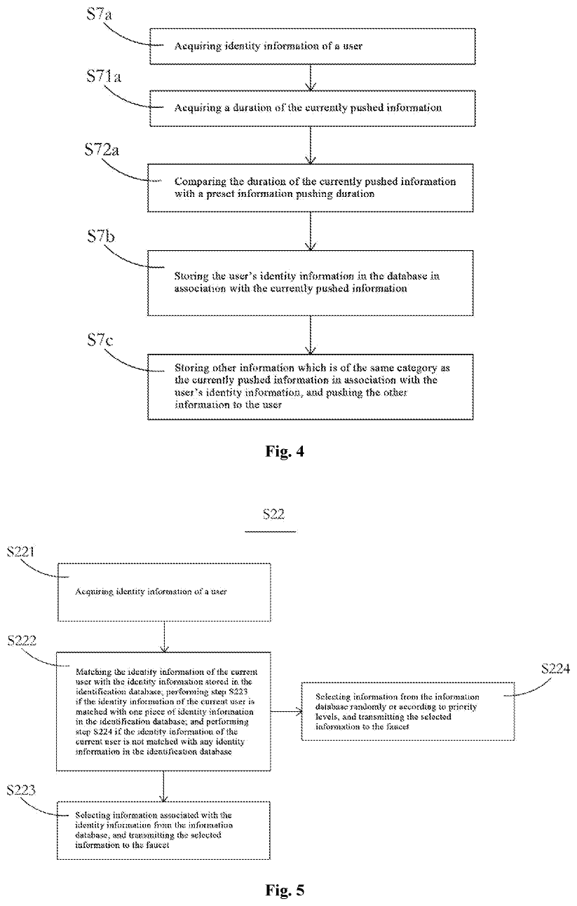

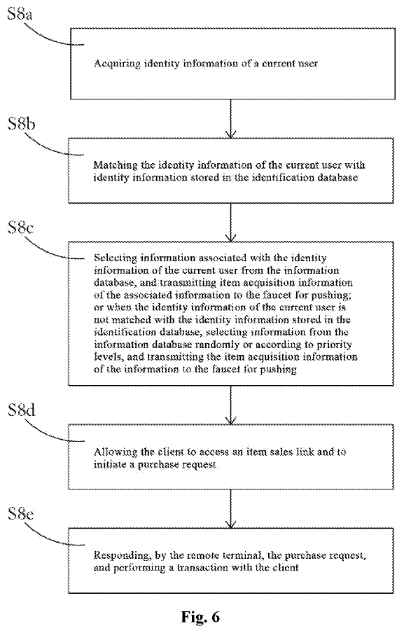

Referring to FIG. 4, the information pushing method for the smart faucet further comprises the following steps:

S7a: acquiring identity information of a user; and

S7b: storing the user's identity information in the information database in association with the currently pushed information.

It may be understood that a face recognition device is arranged on the faucet. When the user washes the hand using the faucet of the present disclosure for the first time, the face recognition device on the faucet first acquires facial features of the user and transmits them to the remote terminal. The remote terminal stores the facial features of the user as the user's identity information in the information database in association with the currently pushed information. It may be understood that the face recognition device is arranged on the upper surface of the faucet obliquely. Because when a person washes his/her hands, his/her body usually shows a forward tilting posture, the oblique face recognition device is substantially parallel to the face of the person, such that the facial features of the person can be captured well, resulting in a more accurate result. As a variation, the face recognition device may also be integrated on a display screen. Alternatively, a MAC identifier recognition device is arranged on the faucet. Many people are accustomed to carry a mobile phone with them. As long as wifi of the user's mobile phone is turned on, the MAC identifier recognition device may recognize a MAC identifier of the user's mobile phone and thus obtain user's relevant information. The remote terminal stores the user's relevant information as the user's identity information in the information database in association with the currently pushed information. It may also be understood that after acquiring the facial features or relevant information of the user, the remote terminal may compare the facial features or the relevant information with the existing identity information database to obtain the identity information of this user. As a variation, the faucet may store the user's identity information in association with the currently pushed information. As another variation, after acquiring the facial features or relevant information of the user, the remote terminal compares the facial features or relevant information with the existing identity information database to obtain the identity information of this user. In general, the identity information stored in the existing identity information database is associated with shopping information, web browsing information, personal attention information, and the like. The remote terminal may store the shopping information, the webpage browsing information and the personal attention information, which are associated with the identity information of this user, in association with the identity information of this user, and select similar information from the information database according to the shopping information content, the webpage browsing information content or the personal attention information content that the user usually pays attention to, and push the information to this user.

For example, when Li washes his/her hands with the faucet of the present disclosure in a hotel for the first time, information pushed by the faucet during the hand washing process is an advertisement for a Toyota car. The faucet obtains the user's relevant information through recognition with a face recognition technology or through recognition with the personal mobile phone MAC identifier, searches and compares the relevant information in the existing identity information database to obtain the user's identity information, and stores the user's identity information in association with the advertisement of the Toyota car. Alternatively, the faucet directly stores the user's relevant information obtained through recognition with the face recognition technology or through recognition with the personal mobile phone MAC identifier in the information database in association with the advertisement of the Toyota car.

It may be understood that when the remote terminal or the faucet presets the information pushing duration, the currently pushed information may be stored in association with the user's identity information only when the duration of the currently pushed information reaches the preset information pushing duration. Therefore, the information pushing method for the smart faucet further comprises the following steps:

S71a: acquiring a duration of the currently pushed information; and

S72a: comparing the duration of the currently pushed information with the preset information pushing duration; storing the currently pushed information in association with the user's identity information if the duration of the currently pushed information is greater than or equal to the preset information pushing duration; or storing the currently pushed information not in association with the user's identity information if the duration of the currently pushed information is less than the preset information pushing duration.

For example, according to the washing habits of ordinary people, the hand washing time is 20 s, and the remote terminal presets the pushing information duration to be 20s. If Li washes his/her hands for 1 minute, and the advertisement pushed by the faucet is the advertisement of Toyota car at this time, then the remote terminal determines that Li is attracted by this advertisement, and thus stores the identity information of Li in association with the advertisement of Toyota car, or giving Li a label of liking cars. If Li only washes his/her hands for 10 s, the remote terminal determines that Li does not like this advertisement, and thus stores the identity information of Li not in association with the advertisement of Toyota car, or gives Li a label of disliking cars. In this way, the content of information on favorites of each user can be recorded in the remote terminal in association with the identity information of the user.

In addition, the database may store information in a classified manner. The information pushing method for the smart faucet further comprises the following steps:

S7c: storing other information which is of the same category as the currently pushed information in association with the user's identity information, and pushing the other information to this user. For example, Li only watches the advertisement of the Toyota car for a long time in a hotel; the remote terminal or the faucet stores the advertisement of the Toyota car, as well as the advertisements of Honda car, Hyundai car, Mercedes-Benz car or cars of other automobile brands as an automobile category advertisement; and then the automobile category advertisement is stored in association with the identity information of Li and pushed to Li.

Referring to FIG. 5, the remote terminal further comprises an identification database in which massive identity information is stored. The remote terminal further comprises an identification database in which identity information is stored, and each piece of identity information is associated with one or more pieces of information in the information database. It may be understood that the identification database may be an internal database of the remote terminal, or may be connected to an external identity information database, such as Alibaba Cloud, Tencent Cloud, or other servers providing identity information. The step S22 specifically comprises the following steps:

S221: acquiring identity information of a current user;

S222: matching the identity information of the current user with the identity information stored in the identification database; performing step S223 if the identity information of the current user is matched with one piece of identity information in the identification database; or performing step S224 if the identity information of the current user is not matched with any identity information in the identification database;

S223: selecting information associated with this identity information from the information database, and transmitting the selected information to the faucet; and

S224: selecting information from the information database randomly or according to a priority level, and transmitting the selected information to the faucet.

It may be understood that the manner of acquiring the identity information of the current user in the step S221 is consistent with that in the step S7a.

In step S222, after acquiring the identity information of the current user, whether the identity information has been stored in the identification database of the remote terminal is determined. If the identity information of the user has been stored in the identification database of the remote terminal, the remote terminal directly retrieves the information associated with the identity information from the information database for pushing. Selective information pushing based on the customers' preferences brings convenience to customers and is more conducive to information pushing. If the identity information of the user is not stored in the identification database of the remote terminal, the remote terminal will select information from the information database randomly or according to a priority level and transmit the selected information to the faucet. The selected information is then pushed by the faucet. In this case, the information selection according to the priority levels for pushing may be performed according to the order of the prices of the plurality of clients from high to low in step S6c; or the information is selected and pushed according to the order that a public service advertisement is pushed preferentially, and then commercial advertisements are pushed.

For example, when Li washes his/her hands with the faucet of the present disclosure for the first time in a public restroom in Shenzhen, the information pushed by the faucet is an advertisement for an Apple mobile phone. When Li travels to Beijing on business and washes his/her hands with the faucet of the present disclosure as well in a public restroom in Beijing, the faucet in Beijing will obtain Li's facial features through the face recognition technology or obtain Li's electronic messages through personal mobile phone MAC identifier recognition, and match the facial features or electronic messages with identity information in the identification database of the remote terminal one by one. If the faucet in Shenzhen at that time had already stored Li's identity information in association with the Apple mobile phone advertisement that was pushed at that time, the Beijing's faucet would push mobile phone category advertisements to Li. If the faucet in Shenzhen at that time did not store the Li's identity information in association with the Apple mobile phone advertisement that was pushed at that time, the faucet in Beijing would be controlled by the remote terminal to push information to Li randomly or according to priority levels.

Referring to FIG. 6, the information pushing method for the smart faucet further comprises the following steps:

S8a: acquiring identity information of a current user;

S8b: matching the identity information of the current user with identity information stored in the identification database;

S8c: selecting information associated with the identity information of the current user from the information database, and transmitting item acquisition information of the associated information to the faucet for pushing; or selecting information from the information database randomly or according to priority levels, and transmitting item acquisition information of this information to the faucet for pushing;

S8d: allowing the client to access the item acquisition information and to initiate a purchase request; and

S8e: responding, by the remote terminal, the purchase request, and performing a transaction with the client.

It may be understood that the manner of acquiring the identity information of the current user in the step S8a is consistent with that in the above steps S7a and S222.

It may be understood that the item acquisition information corresponding to each piece of information is stored in the information database of the remote terminal. The item acquisition information may be a link to the remote terminal itself or a link connected to an external shopping website. When the user's identity information is stored in the identification database of the remote terminal, the remote terminal selects information associated with the identity information of the current user from the information database, and transmits the item acquisition information of the associated information to the faucet for pushing. When the user's identity information is not stored in the identification database of the remote terminal, the remote terminal selects information from the information database randomly or according to priority levels, and transmits the item acquisition information of this information to the faucet for pushing. In this way, relevant items can be pushed with respect to the type of information on favorites of each user, which brings great convenience to people's lives and makes intelligent life easier.

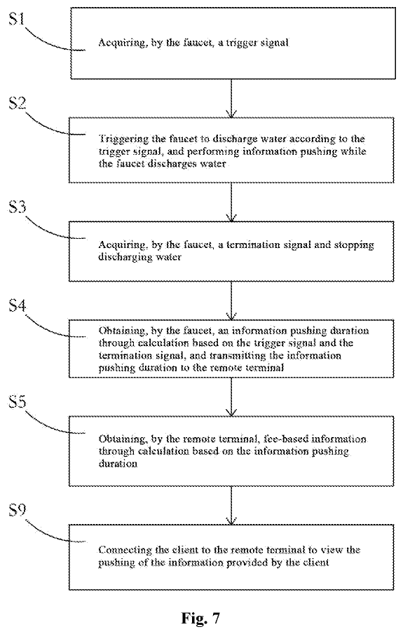

In addition, referring to FIG. 7, the information pushing method for the smart faucet further comprises the following step S9.

In step S9, the clients are connected to the remote terminal to view the pushing of the information provided by the clients. It may be understood that a background interface is arranged on the remote terminal, and is connected to a quantization platform in which relevant data of all information in the remote terminal is stored. The information provider may access the quantization platform of the remote terminal through his/her client to view the pushing of the information provided by the information provider, for example, one or more of the related parameters such as the number of pushing times, the push duration, the push location, and the pushing time.

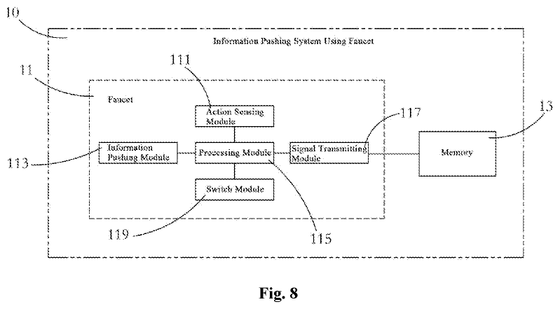

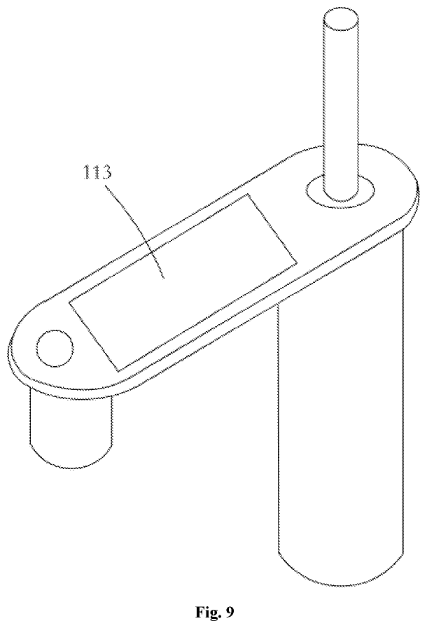

Referring to FIG. 8, the second embodiment of the present disclosure further provides an information pushing system 10 for a smart faucet. The information pushing system 10 for the smart faucet comprises:

a faucet 11, comprising an action sensing module 111 configured to acquire a trigger signal and a termination signal;

an information pushing module 113 configured to start information pushing according to the trigger signal;

a processing module 115 configured to obtain an information pushing duration through calculation based on the trigger signal and the termination signal;

a communicating module 117 configured to communicate with a memory;

the memory 13; and one or more programs, one or more programs being stored in the memory, the memory being in communication with the faucet, and the program being used for executing the following step instruction:

obtaining fee-based information through calculation based on the information pushing duration.

The action sensing module 111 will generate a first electrical signal after acquiring the trigger signal, and transmit the first electrical signal to the processing module 115. Meanwhile, the action sensing module 111 records a time point at which the trigger signal is acquired and transmits the time point to the processing module 115. The processing module 115 immediately controls the information pushing module 113 to start information pushing; or the information pushing module 113 performs information pushing all the time, and the processing module 115 records the time point at which the trigger signal is acquired as a starting point of the information pushing timing. The action sensing module 111 will generate a second electrical signal after acquiring the termination signal, and then transmit the second electrical signal to the processing module 115. Meanwhile, the action sensing module 111 records a time point at which the termination signal is acquired and transmits this time point to the processing module 115. The processing module 115 takes the time point at which the termination signal is acquired as a termination point of the information pushing timing. In addition, the processing module 115 calculates the information pushing duration based on the time point at which the trigger signal is acquired and the time point at which an initial action signal is acquired, and transmits the information pushing duration to the memory 13 through the communicating module 117. The program stored in the memory 13 starts to execute the following step instruction:

obtaining fee-based information through calculation based on the information pushing duration.

As a variation, after the processing module 115 transmits the time point at which the trigger signal is acquired and the time point at which the termination signal is acquired to the memory 13, the program stored in the memory 13 further executes the following instruction:

calculating an information pushing duration.

In addition, the faucet 11 further comprises a switch module 119 configured to control the faucet to start to discharge water or stop discharging water according to the trigger signal or the termination signal. The processing module 115 controls the switch module 119 to start to discharge water after receiving the first electrical signal.

In addition, the information pushing module is arranged on the upper surface of the faucet obliquely. When a person washes his/her hands, his/her body usually shows a forward tilting posture. When the information pushing module is arranged on the upper surface of the faucet obliquely, the information pushing module is substantially parallel to the person's face. At this time, the person is easily attracted by the information pushed on the information pushing module. Therefore, the information pushing module not only meets the ergonomic requirements, but also attracts people's attention to the pushed information.

In addition, the program further executes the following step instruction:

selecting information to be pushed and transmitting the selected information to the faucet.

In addition, when the plurality of clients feeds back the bidding information respectively, the program further executes the following step instructions:

comparing the plurality of bidding information;

selecting one or more clients according to a comparison result; and

storing information transmitted by the selected clients.

In addition, when the memory comprises an information database, the program further executes the following step instructions:

acquiring identity information of a user; and

storing the user's identity information in association with the currently pushed information.

In addition, when the memory stores the information in a classified manner, the program further executes the following step instruction:

storing other information which is of the same category as the currently pushed information in association with the user's identity information.

In addition, when the remote terminal further comprises an identification database in which identity information is stored, the identity information being associated with one or more signals in the information database. The program further executes the following step instructions:

S221: acquiring identity information of a current user;

S222: matching the identity information of the current user with the identity information stored in the identification database; performing step S223 if the identity information of the current user is matched with one piece of identity information in the identification database; and performing step S224 if the identity information of the current user is not matched with any identity information in the identification database;

S223: selecting information associated with this identity information from the information database, and transmitting the selected information to the faucet; and

S224: selecting information from the information database randomly or according to priority levels, and transmitting the selected information to the faucet.

In addition, when the remote terminal further comprises an identification database in which identity information is stored, the identity information being associated with one or more signals in the information database, the program further executes the following step instructions:

S8a: acquiring identity information of a current user;

S8b: matching the identity information of the current user with identity information stored in the identification database;

S8c: selecting information associated with the identity information of the current user from the information database, and transmitting item acquisition information of the associated information to the faucet for pushing; or when the identity information of the current user is not matched with the identity information stored in the identification database, selecting information from the information database randomly or according to priority levels, and transmitting item acquisition information of this information to the faucet for pushing;

S8d: allowing the client to access the item acquisition information and to initiate a purchase request; and

S8e: responding, by the remote terminal, the purchase request, and performing a transaction with the client.

Referring to FIG. 9, a display screen 113, i.e., the information pushing module 113, is arranged on the upper surface of the faucet 11 of the present disclosure. When a user stretches his/her hands to be washed, his/her body usually leans forward and his/her eyes will pay attention to the positions of his/her hands. The display screen 113 in this case is located just below the user's sight, and the user certainly sees information pushed on the display screen 113. Therefore, the duration of the user viewing the pushed information, which is obtained through calculation based on the trigger signal and the termination signal is true and accurate. Moreover, the position of the display screen 113 also meets ergonomic requirements, thereby bringing an intelligent living experience to people in their daily lives. It may be understood that the structural description of the faucet 11 in this embodiment is also applicable to other embodiments of the present disclosure.

The information pushing method for the smart faucet of the present disclosure differs from the prior art in that: the faucet is configured to be connected with the remote terminal. The information pushing method for the smart faucet comprises the following steps: S1: acquiring, by the faucet, a trigger signal; S2: triggering the faucet to discharge water according to the trigger signal, and meanwhile performing information pushing while the faucet discharges water; S3: acquiring, by the faucet, a termination signal and stopping discharging water; S4: obtaining, by the faucet, an information pushing duration through calculation based on the trigger signal and the termination signal, and transmitting the information pushing duration to the remote terminal; and S5: obtaining, by the remote terminal, fee-based information through calculation based on the information pushing duration. According to the information pushing method for the smart faucet of the present disclosure, the information pushing duration is obtained through calculation based on the trigger signal and the termination signal, and the fee-based information is obtained through calculation based on the information pushing duration. Therefore, the duration during which a user actually receives the information pushed by the faucet is really reflected, real statistical data can be provided for an information provider, and meanwhile, the intelligence life experience is brought about to users.

In addition, according to the information pushing method for the smart faucet, the number of times of information pushing is obtained on the basis of the number of times that the remote terminal transmits information to the faucet, and the fee-based information is obtained through calculation based on the number of times of information pushing and the information pushing duration. Therefore, the duration during which the user actually receives the information pushed by the faucet is reflected more really.

In addition, the information pushing method for the smart faucet according to the present disclosure can provide a bidding platform for an information provider, so that the information provided by the information provider can be pushed to the public on the faucet.

In addition, according to the information pushing method for the smart faucet of the present disclosure, the identity information of the user is obtained by using a face recognition technology or by personal mobile phone MAC identifier recognition. The user's identity information is stored in association with the currently pushed information, or other information which is of the same category as the currently pushed information is stored in association with the user's identity information. The user is labeled according to types of user's favorite information. When the user continues to use the faucet of the present disclosure to wash hands later, the remote terminal may select to push the user's favorite information or an item sales link corresponding to this information. A better user experience is brought to each user by pushing his/her favorite information or item sales links. In addition, the entire information processing process is fast and easy, which is conductive to promotion and application of intelligent home products.

Moreover, the information pushing system for the smart faucet of the present disclosure also has the above-mentioned advantages.

The above content is only the preferred embodiments of the present disclosure and is not intended to limit the present disclosure. Any modifications, equivalent replacements, and improvements made within the principles of the present disclosure should be included in the protection scope of the present disclosure.

1. An information pushing method for a smart faucet, a faucet being configured to be connected with a remote terminal, wherein the information pushing method for the smart faucet comprises the following steps:
S1: acquiring, by the faucet, a trigger signal;
S2: starting information pushing timing according to the trigger signal;
S3: acquiring, by the faucet, a termination signal and terminating the information pushing timing;
S4: obtaining, by the faucet, an information pushing duration through calculation based on the trigger signal and the termination signal, and transmitting the information pushing duration to the remote terminal; or transmitting, by the faucet, the trigger signal and the termination signal to the remote terminal, and obtaining, by the remote terminal, an information pushing duration through calculation; and
S5: obtaining, by the remote terminal, fee-based information through calculation based on the information pushing duration.

2. The information pushing method for the smart faucet according to claim 1, wherein in step S2, the faucet is triggered to discharge water while performing the information pushing timing according to the trigger signal; and in step S4, the faucet stops discharging water while acquiring the termination signal and terminating the information pushing timing.

3. The information pushing method for the smart faucet according to claim 1, wherein the step S2 specifically comprises the following steps:
S21: generating, by the faucet, a feedback signal according to the trigger signal, and transmitting the feedback signal to the remote terminal; and
S22: receiving, by the remote terminal, the feedback signal, and then transmitting a control signal to the faucet to control the faucet to perform information pushing.

4. The information pushing method for the smart faucet according to claim 3, wherein the remote terminal comprises an information database in which information to be pushed is stored, and the step S22 is specifically as follows:
the remote terminal selects information to be pushed from the information database and transmits the information to the faucet which then pushes the selected information.

5. The information pushing method for the smart faucet according to claim 4, wherein the information pushing method for the smart faucet further comprises the following steps:
S6a: acquiring, by a plurality of clients, bidding notification information from the remote terminal;
S6b: feeding back, by the plurality of clients, bidding information to the remote terminal, respectively;
S6c: comparing, by the remote terminal, the plurality of bidding information;
S6d: selecting, by the remote terminal, one or more clients according to a comparison result; and
S6e: transmitting, by the selected client, the information that needs to be pushed to the remote terminal, and saving the information to the information database.

6. The information pushing method for the smart faucet according to claim 4, wherein the information pushing method for the smart faucet further comprises the following steps:
S7a: acquiring identity information of a user; and
S7b: storing the user's identity information in the information database in association with the currently pushed information.

7. The information pushing method for the smart faucet according to claim 6, wherein the database stores the information in a classified manner, and the information pushing method for the smart faucet further comprises the following step:
S7c: storing other information which is of the same category as the currently pushed information in association with the user's identity information, and pushing the other information to the user.

8. The information pushing method for the smart faucet according to claim 4, wherein the remote terminal further comprises an identification database in which identity information is stored, the identity information being associated with one or more pieces of information in the information database; and the step S22 specifically comprises the following steps:
S221: acquiring identity information of a current user;
S222: matching the identity information of the current user with the identity information stored in the identification database; performing step S223 if the identity information of the current user is matched with one piece of identity information in the identification database; and performing step S224 if the identity information of the current user is not matched with any identity information in the identification database;
S223: selecting information associated with the identity information from the information database, and transmitting the selected information to the faucet; and
S224: selecting information from the information database randomly or according to priority levels, and transmitting the selected information to the faucet.

9. The information pushing method for the smart faucet according to claim 8, wherein in the step S221, the identity information is obtained by using face recognition or personal mobile phone MAC identifier recognition.

10. The information pushing method for the smart faucet according to claim 4, wherein the remote terminal further comprises an identification database in which identity information is stored, the identity information being associated with one or more pieces of information in the information database; and the information pushing method for the smart faucet further comprises the following steps:
S8a: acquiring identity information of a current user;
S8b: matching the identity information of the current user with identity information stored in the identification database;
S8c: selecting information associated with the identity information of the current user from the information database, and transmitting item acquisition information of the associated information to the faucet for pushing; or when the identity information of the current user is not matched with the identity information stored in the identification database, selecting information from the information database randomly or according to priority levels, and transmitting the item acquisition information of the information to the faucet for pushing;
S8d: allowing the client to access the item acquisition information and to initiate a purchase request; and
S8e: responding, by the remote terminal, the purchase request, and performing a transaction with the client.

11. The information pushing method for the smart faucet according to claim 10, wherein in the step S8a, the identity information is obtained by using face recognition or personal mobile phone MAC identifier recognition.

12. The information pushing method for the smart faucet according to claim 1, wherein the trigger signal is acquired by sensing user's hands reaching a prescribed area or by sensing a user who approaches the faucet; and the termination signal is acquired by sensing the user's hands leaving from the prescribed area or by sensing the user moving away from the faucet.

13. An information pushing system for a smart faucet, comprising:
a faucet which comprises an action sensing module configured to acquire a trigger signal and a termination signal;
an information pushing module configured to start information pushing according to the trigger signal;
a processing module configured to obtain an information pushing duration through calculation based on the trigger signal and the termination signal;
a communicating module configured to communicate with a memory;
the memory; and one or more programs, one or more programs being stored in the memory, the memory being in communication with the faucet, and the program being used for executing the following step instruction:
obtaining fee-based information through calculation based on the information pushing duration.

14. The information pushing system for the smart faucet according to claim 13, wherein the faucet further comprises a switch module configured to control the faucet to discharge water or stop discharging water according to the trigger signal or the termination signal.

15. The information pushing system for the smart faucet according to claim 13, wherein when the memory comprises an information database, the program further executes the following step instructions:
acquiring identity information of a user; and
storing the user's identity information in association with the currently pushed information.

16. The information pushing system for the smart faucet according to claim 15, wherein when the memory comprises an identification database, the program further executes the following step instructions:
S221: acquiring identity information of a current user;
S222: matching the identity information of the current user with the identity information stored in the identification database; performing step S223 if the identity information of the current user is matched with one piece of identity information in the identification database; or performing step S224 if the identity information of the current user is not matched with any identity information in the identification database;
S223: selecting information associated with the identity information from the information database, and transmitting the selected information to the faucet; and
S224: selecting information from the information database randomly or according to priority levels, and transmitting the selected information to the faucet.

17. The information pushing system for the smart faucet according to claim 15, wherein when the memory comprises an identification database, the program further executes the following step instructions:
S8a: acquiring identity information of a current user;
S8b: matching the identity information of the current user with identity information stored in the identification database;
S8c: selecting information associated with the identity information of the current user from the information database, and transmitting item acquisition information of the associated information to the faucet for pushing; or when the identity information of the current user is not matched with the identity information stored in the identification database, selecting information from the information database randomly or according to priority levels, and transmitting the item acquisition information of the information to the faucet for pushing;
S8d: allowing the client to access the item acquisition information and to initiate a purchase request; and
S8e: responding, by the remote terminal, the purchase request, and performing a transaction with the client.

18. The information pushing system for the smart faucet according to claim 13, wherein the information pushing module is arranged on an upper surface of the faucet obliquely.
